(19) United States
(12) Patent Application Publication
(10) Pub. No.: US 2016/0267932 A1
(43) Pub. Date: Sep. 15, 2016

(54) MAGNETIC DISK DEVICE AND METHOD FOR DETERMINING FLOATING OF MAGNETIC HEAD

(71) Applicant: Kabushiki Kaisha Toshiba, Tokyo (JP)

(72) Inventor: Hiroaki Sato, Yokohama Kanagawa (JP)

(21) Appl. No.: 14/839,319

(22) Filed: Aug. 28, 2015

Related U.S. Application Data
(60) Provisional application No. 62/131,095, filed on Mar. 10, 2015.

(51) Int. Cl. G11B 5/60

(52) U.S. Cl. CPC G11B 5/6029

(57) ABSTRACT

According to one embodiment, a magnetic disk device is disclosed. The magnetic disk device includes a magnetic disk including a plurality of tracks. The plurality of tracks each includes a plurality of servo areas, and the plurality of servo areas each include first servo data including data regarding eccentricity of the magnetic disk. The magnetic disk device further includes a head configured to write data to the magnetic disk and read data written to the magnetic disk. The magnetic disk device further includes a controller configured to determine whether floating of the head from the magnetic disk is abnormal or not based on a signal corresponding to the first servo data read by the head while writing the data on the magnetic disk by the head.

### CROSS-REFERENCE TO RELATED APPLICATIONS

This application claims the benefit of U.S. Provisional Application No. 62/131,095, filed Mar. 10, 2015, the entire contents of which are incorporated herein by reference.

### FIELD

Embodiments described herein relate generally to a magnetic disk device and a method of determining floating of a magnetic head.

### BACKGROUND

In recent years, recording density of magnetic disk device has been improving remarkably. With the improvement in the recording density of the magnetic disk device, a spacing between a magnetic head and a recording surface of a magnetic disk has been narrowed progressively.

The progress of the narrow spacing causes higher probability of failure due to a high-fly write. The HFW-related failure is a phenomenon that data is written to the magnetic disk by the magnetic head at a spacing greater than the usually set spacing. When the data is written to the magnetic disk by the magnetic head at the high spacing, probability of occurrence of error at the time of reading the data (read error) is increased.

### BRIEF DESCRIPTION OF THE DRAWINGS

FIG. 1 is a diagram showing a configuration of a magnetic disk device of an embodiment;

FIG. 2 is a diagram showing a configuration of recording surface of a magnetic disk;

FIG. 3 is a diagram showing arrangement of a servo frame on a truck;

FIG. 4 is a diagram showing a configuration of a servo frame;

FIG. 5 is a flowchart illustrating a detection method of HFW failure in the embodiment;

FIG. 6 is a diagram schematically showing an example of RRO gain, gain slice and gain average;

FIG. 7 a flowchart illustrating another detection method of the HFW failure in the embodiment; and

FIG. 8 is a diagram schematically showing an example of averages of RRO gains, sums of average of the RRO gains and an offset, and gain slices.

### DETAILED DESCRIPTION

Embodiments will now be described with reference to drawings. In the drawings, parts corresponding to those of a figure already described are designated by the same references of the figure (including those with different subscripts), and detailed descriptions therefore will be omitted.

In general, according to one embodiment, a magnetic disk device is disclosed. The magnetic disk device comprises a magnetic disk including a plurality of tracks. The plurality of tracks each includes a plurality of servo areas each containing the first servo data containing data relating to the eccentricity of the magnetic disk. The magnetic disk device further comprises a head configured to write data to a magnetic disk and read the data written to the magnetic disk. The magnetic disk device further comprises a controller configured to determine whether the floating of the head from the magnetic disk is abnormal or not based on the signal corresponding to the first servo data read by the head while writing the data to the magnetic disk by the head.

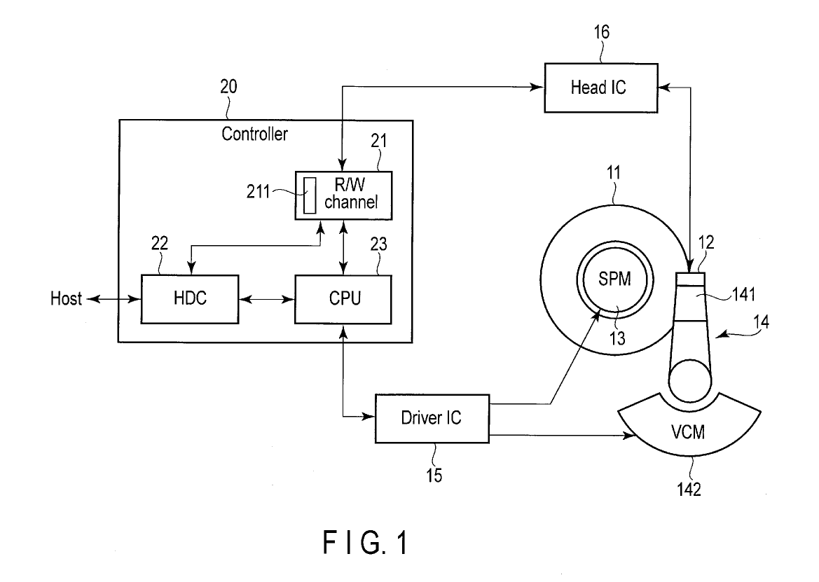

FIG. 1 shows a configuration of the magnetic disk device of a present embodiment.

The magnetic disk device comprises a magnetic disk 11, a head 12, a spindle motor (SPM) 13, an actuator 14, a driver IC 15, a head IC 16 and a controller 20.

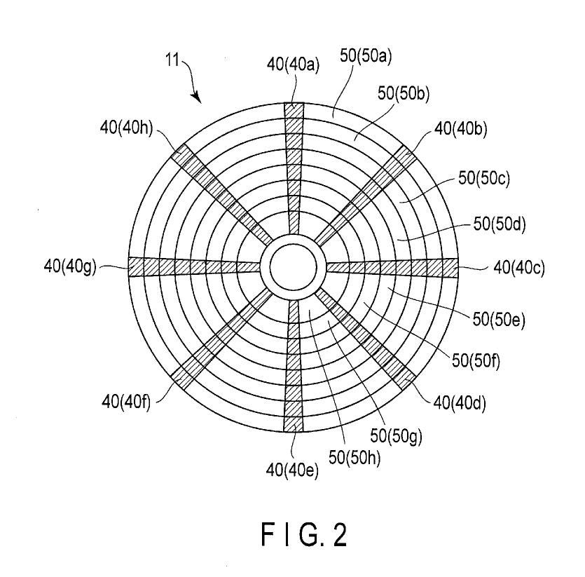

FIG. 2 shows a configuration of a recording surface of the magnetic disk 11.

The recording surface of the magnetic disk 11 is provided with a plurality of servo areas 40 (40a to 40h) extended in a radial direction from a central part of the magnetic disk 11. FIG. 2 shows eight servo areas 40, but the number of servo areas 40 is not limited to eight.

The recording surface of the magnetic disk 11 is divided radially into a plurality of zones (not shown) to be managed. Each zone includes a number of, for example, several thousands of tracks. For simplification, FIG. 2 shows eight concentrically arranged tracks 50 (50a to 50h). In FIG. 2, the tracks are arranged concentrically, but they may be arranged spirally.

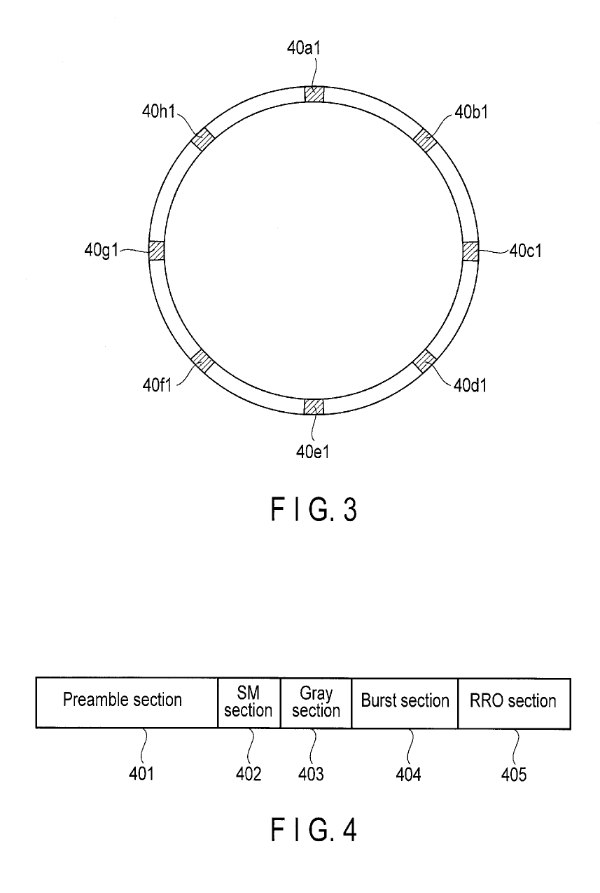

Each track includes a plurality of servo areas (servo frame) intermittently (discretely) arranged along a circumferential direction thereof. For example, an outermost track 50a contains eight servo frames 40a1, 40b1, 40c1, 40d1, 40e1, 40f1, 40g1 and 40h1 intermittently (discretely) arranged along the circumferential direction as shown in FIG. 3.

The servo frame contains servo data recorded therein and used to perform position control of the head 12, and the like. An area between two circumferentially adjacent servo frames is a data area. Each data area is configured to record user data. The user data area is divided into a plurality of sectors (not shown). Recording/reproduction of data is carried out in units of sectors.

As shown in FIG. 4, each servo frame includes a preamble section 401, a servo mark (SM) section 402, a Gray code (Gray) section 403, a burst section 404 and a repeatable run-out (RRO) section 405.

The servo data is written by, for example, an exclusive-use write device called a servo track writer (STW), or by the head of a magnetic disk device itself in a self-servo-write (SSW) mode. In the case of the former, after the sections other than the RRO section 405 in the servo data is recorded by the STW, the RRO section 405 is written by the head in a state where the magnetic disk is mounted in the magnetic disk device.

To the RRO section 405, correction data to control repeatable run-out (RRO) is written. The repeatable run-out indicates variations due to the eccentricity of a magnetic disk, etc., and occurs repeatedly in the same manner each time the magnetic disk rotates as a cycle.

With reference to FIG. 1 again, the head 12 is provided to correspond to the recording surface of the magnetic disk 11. The head 12 comprises a write element and a read element which are not shown in the figure. The write element is used to write data to the magnetic disk 11. The read element is used to read data from the magnetic disk 11.

FIG. 1 shows a configuration that the magnetic disk device includes one magnetic disk 11, but in practice, the magnetic disk device may include two or more magnetic disks. A plurality of magnetic disks are arranged in a multi-layered manner. FIG. 1 also shows a configuration that only the upper surface of the magnetic disk 11 is a recording surface, but in practice, the lower surface of the magnetic disk 11 as well may be a recording surface. In this case, heads are arranged to correspond to the both recording surfaces of the magnetic disk 11.

The magnetic disk 11 is rotated by the SPM 13. The SPM 13 is driven by a current (or voltage) supplied from the driver IC 15. The head (head slide) 12 is attached at a distal end of an arm 141 of the actuator 14. The actuator 14 includes a voice coil motor (VCM) 142. The VCM 142 is driven by a current (or voltage) supplied from the driver IC 15. The head 12 is driven by the VCM 142 of the actuator 14.

The driver IC 15 drives the SPM 13 and VCM 142 according to control of the controller 20 (more specifically, the CPU 23). The head IC 16 is also called head amplifier and amplifies a signal (that is, read signal) read by the head 12. Further, the head IC 16 converts write data output from the controller 20 (more specifically, R/W channel 21) into a write current to be output to the head 12.

The controller 20 comprise a read/write channel (R/W channel) 21, a disc controller (referred to as the HDC hereafter) 22 and a CPU 23. The R/W channel 21, HDC 22 and CPU 23 are realized by, for example, a system-on-a-chip (SOC).

The R/W channel 21 processes a signal relating to reading and writing. For example, the R/W channel 21 converts read signal amplified by head IC 16 into digital data and decodes read data from this digital data. Further, the R/W channel 21 extracts servo data from the digital data. Furthermore, the R/W channel 21 codes write data transferred from the HDC 22 and transmits the coded write data to the head IC 16.

Further, the R/W channel 21 comprises an automatic gain control (AGC) amplifier 211. The AGC amplifier 211 amplifies a read signal to a fixed potential, before converting a read signal sent from the head IC 16 into a digital signal. As the potential of the read signal is lower, the gain of the AGC amplifier 211 corresponding to the read signal is higher. The data regarding the gain of AGC amplifier 211 is sent to the HDC 22. In the present embodiment, the HFW-related failure is detected based on the gain of an RRO signal read from the RRO section 405, as will be described later.

The HDC 22 controls writing to and reading from the magnetic disk 11 through the R/W channel 21, the head IC 16 and the head 12.

The HDC 22 is connected to a host through a host interface (not shown). The host uses the magnetic disk device shown in FIG. 1 as a storage device of its own. The host and the magnetic disk device shown in FIG. 1 are provided in electronic apparatuses such as personal computers, video cameras, music players, personal digital assistants, cellular phones and printers. The HDC 22 receives commands such as read and write from the host. The HDC 22 controls the write of data to the magnetic disk 11, or read of data from the magnetic disk 11 through the head IC 16, the head IC 12 and the R/W channel 21 based on the commands.

The CPU 23 controls the SPM 13 and the VCM 142 through the driver IC 15. For example, the CPU 23 controls the VCM 142 in order to position the head 12 in the target position of the target track on the magnetic disk 11.

In the present embodiment, the head 12 is positioned by virtual circle control. In the virtual circle control, the position of the head 12 is controlled by circular orbit (virtual circle) which does not follow the center of the servo data recorded on the magnetic disk 11. The center of the virtual circle is the center of rotation of the magnetic disk 11, that is, an axial center of the SPM 13. The center of servo data recorded on the magnetic disk 11 loaded in the magnetic disk device and the axial center of the SPM 13 do not completely coincide, and deviation (eccentricity) is occurred between them. The servo data regarding the eccentricity of the magnetic disk 11 with respect to the axial center of the SPM 13 is recorded on the RRO section 405. By using the preamble section 401, the SM section 402, the Gray section 403, the burst section 404, and the RRO section 405, the position of the head 12 is controlled by the circular orbit which does not follow the center of the servo data recorded on the magnetic disk 11.

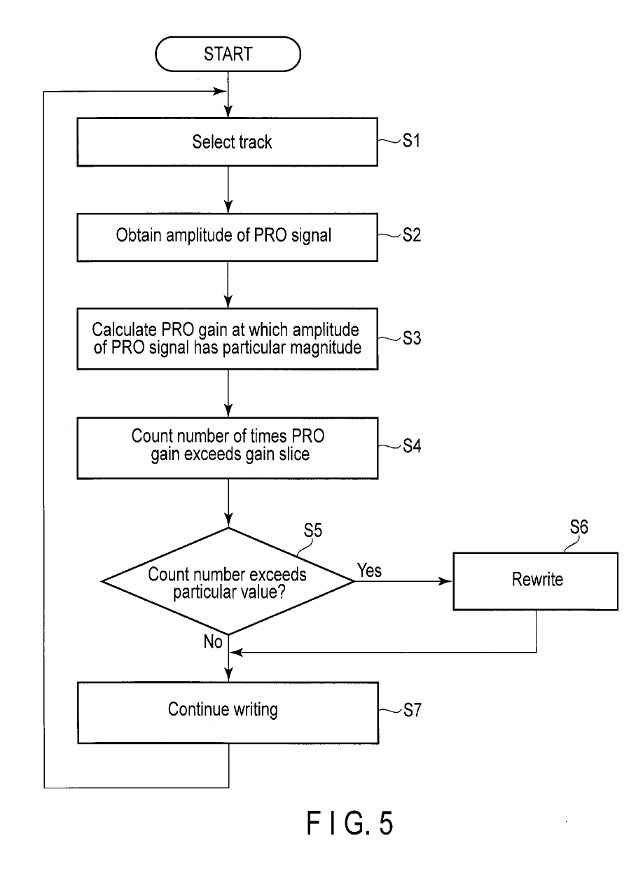

FIG. 5 is a flowchart illustrating a detection method of the HFW-related failure in the present embodiment. In this detection method, an HFW detection slice is set for each head/zone.

[Process S1]

A track to be subjected to write of data is selected.

[Process S2]

With respect to the selected track, the operation (write operation) of writing data to the magnetic disk 11 by the head 12 (write element) is started. The signal (RRO signal) corresponding to the data written to the RRO section 405 read by the head 12 (read element) for write operation is input to the AGC amplifier 211. In the AGC amplifier 211, the amplitude (potential) Vpc of the input RRO signal is obtained.

[Process S3]

The AGC amplifier 211 calculates the gain (RRO gain) at which the amplitude (potential) Vpc of the input RRO signal has a particular magnitude.

[Process S4]

The controller 20 monitors the RRO gain, and compares the calculated RRO gain with a particular value (gain slice), and counts number of times that the RRO gain exceeds the gain slice.

The gain slice is expressed by the sum of the average of RRO gains (gain average) and an arbitrary offset amount. The gain average is acquired, for example, in the manufacturing process of the magnetic disk device. More specifically, the gain average is acquired for each zone of the magnetic disk 11 in the manufacturing process. Therefore, when the gain average is different from one zone to another, the gain slice as well differs from one zone to another.

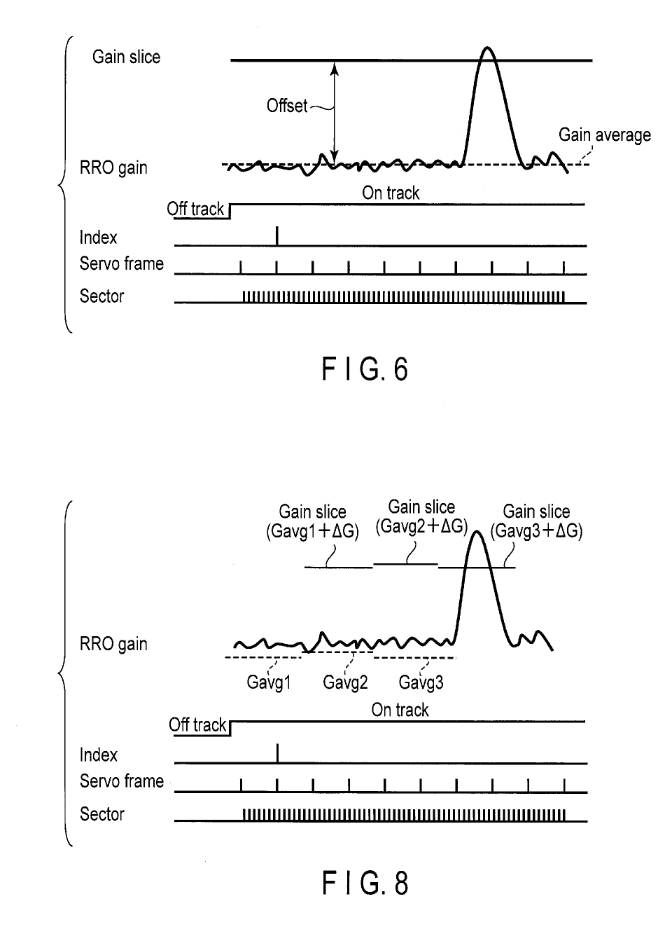

FIG. 6 schematically shows an example of the RRO gain (RRO gain) of the RRO signal of the servo area 40a on the track 50a of FIG. 1, the gain slice and the gain average.

The counting by the AGC amplifier 211 is started when a transition from an off-track state (off track) to an on-track state is occurred. In FIG. 6, the sector indicates a specific position of a recording unit (for example, head of the recording unit) of the data area. Further, the servo frame indicates a specific position of the servo area (for example, head of the servo area). The servo frames are numbered from 0, and the index indicates the servo frame having a servo frame number=0.

The controller 20 monitors the RRO gain, after shifting from the off-track state to the on-track state. Whether or not the RRO gain exceeds the gain slice is detected in synchronism with the servo frame. For example, in the case of FIG. 6, the number of times that the RRO gain exceeds the gain slice is 1.

[Process S5]

The controller 20 determines whether the number of times that successively becomes RPO gain>gain slice (serial count) exceeds a particular value. The particular value is a natural number of 1 or greater.

[Process S6]

When the serial count exceeds the particular value in process S4, the controller 20 determines that an HFW-related failure (abnormality) occurs. Then, the controller 20 controls the driver IC 15 and the head IC 16 so as to stop the write operation. Thereafter, the controller 20 controls the driver IC 15 and the head IC 16 so that the write operation is performed again to the data area which is determined as the HFW-related failure occurred.

[Process S7]

When the serial count is less than or equal to the particular value after the process S6 or in the process S5, the controller 20 controls the driver IC 15 and the head IC 16 so that the write operation is continued. When the writing of data to the selected track is completed, the process returns to the process S1 to select the next track to which the next data is to be written.

The data of the RRO section 405 is written to the magnetic disk loaded in the magnetic disk device and thus the deviation between the center of the track of the RRO section 405 and the axis of rotation of the magnetic disk becomes sufficiently small.

Therefore, for example, even if the head moves from one track to another during the write operation by virtual circle control, the probability of the amplitude of the RRO signal significantly varying is low despite the HFW-related failure not occurring. Therefore, the value of the gain slice can be made small and the accuracy of detection of the HFW-related failure can be increased. In addition, as mentioned above, the gain average is obtained for each zone, the gain average of the on-track zone is used as a set value for the slice. Hence, the set value of the slice usually varies from one zone to another.

The process S1 will now be described in connection with an example of sequential writes to tracks 50a to 50h.

First, the RRO signal of the servo area 40a on the outermost track 50a shown in FIG. 2 (servo frame 40a1 of FIG. 3) is input to the AGC amplifier 211. The information regarding the read position of the servo frame is calculated from the data stored in the Gray code section.

Next, the RRO signals of servo areas 40b, 40c, 40d, 40e, 40f, 40g and 40h (servo frames 40b1 40c1, 40d1, 40e1, 40f1, 40g1 and 40h1 in FIG. 3) of the track (50a) shown in FIG. 2 are input sequentially to the AGC amplifier 211.

Thereafter, the RRO signals of servo areas 40a to 40h (servo frames) on track 50b inner than the track 50a by one track are input sequentially to the AGC amplifier 211.

Hereafter in the same manner, the RRO signals of servo areas 40a, 40b, 40c, 40d, 40e, 40f, 40g and 40g (servo frame) on tracks 50c, 50d, 50e, 50f, 50g and 50h are input sequentially to the AGC amplifier 211.

The above example is a sequential write which carries out one round of writing from the outermost track 50a to the innermost track 50h sequentially one by one. But the detection method of the present embodiment is applicable also to a sequential write which carries out one round of writing from the innermost track 50h to the outermost track 50a sequentially one by one.

It is noted that the functions for performing processes S1 to S7 described above are executed mainly by the controller 20 (especially, the CPU 23), which is not particularly limited as long as it is the element of the magnetic disk device.

In other words, processes S1 to S7 may be performed by at least one of the AGC amplifier 211, HDC 22, CPU 23 and other elements.

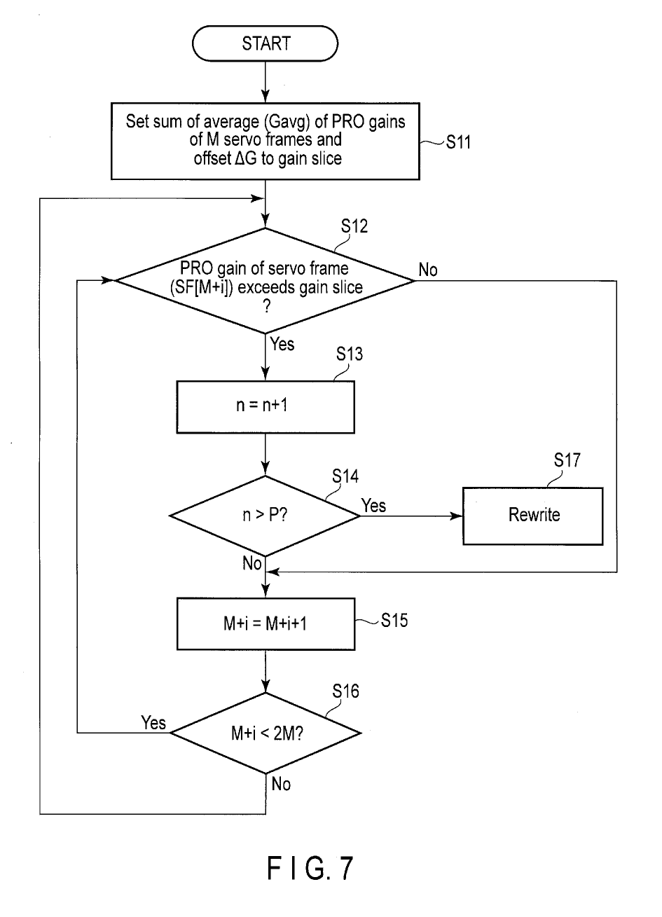

FIG. 7 is a flowchart illustrating another detection method of the HFW-related failure in the embodiment. In this detection method, an HFW detection slice is set for each head/cylinder.

[Process S11]

The controller 20 calculates an average (Gavg) of the RRO gains for M-number of servo frames (SF[1], SF[2], . . . , SF[M−1] and SF [M]) after the head is on-track to the target cylinder, and a sum (Gavg+ΔG) of Gavg and an arbitrary offset of (ΔG) is set as a gain slice.

[Process S12]

The controller 20 determines whether the RRO gain of the M+i^{-th} servo frame (SF[M+i]) at the time of writing exceeds the gain slice set by process S11. The initial value of i is 1. In the case where the HFW detection slice is set for each head/cylinder, the gain slice is calculated and set with M servo frames arbitrarily set from the servo frame in which the head is on-track and the writing of data is started, and then the determination is started as to whether the gain slice has been exceeded from the M+1^{-th} servo frame.

[Process S13]

When the RRO gain exceeds the gain slice in process S12 (Yes), the controller 20 increments the count (n) and updates the count (n=n+1). The initial value of n is zero.

[Process S14]

The controller 20 determines whether the count n updated in the process S13 exceeds a particular value P. The particular value P is a natural number of 1 or more. At the first time (when determining in process S14 for the first time), the count n does not exceed the particular value P since the count n in process S13 is zero (initial value).

[Process S15]

When the count n does not exceed the particular value P in process S14 (No), or when the RRO gain does not exceed the gain slice in process 12 (No), the controller 20 increments the servo frame number [M+i] and updates the servo frame number (M+i=M+i+1).

[Process S16]

In process S15, it is determined whether the updated servo frame number [M+i] is less than 2M. That is, it is determined whether process 12 is executed on M servo frames from the M+i^{-th} frame to 2M^{-th} frame.

When the result of determination of process S16 is Yes, that is, when there are servo frames remaining not subjected to process 12, process 12 is executed on the servo frame (SF [M+i]) which has the updated servo frame number.

[Process S17]

On the other hand, when the count n exceeds the particular value P in process S14 (Yes), that is, when the RRO gain continuously exceeds the gain slice only the number of times corresponding to the particular value P that after the loop of processes 12, 13, 14, 15 and 16 is repeated a certain number of times, the controller 20 determines that the HFW-related failure is occurred. And, the controller 20 controls the driver IC 15 and the head IC 16 so as to stop the write operation. After that, the controller 20 controls the driver IC 15 and the head IC 16 so as to restart the write operation onto the data area determined to have the occurrence of the HFW-related failure. Here, when the particular value P is a natural number of 2 or more, the count n exceeding the particular value P is equivalent to that the RRO gains of sequential servo frames exceed the respective gain slices continuously.

On the other hand, when the result of determination of process S16 is No, that is, when process 12 is executed on M servo frames from the M+i^{-th} frame to the 2M^{-th} frame, process S11 is executed on the following M servo frames from the M+i^{-th} frame. In this way, in the present embodiment, the average of the RRO gains of the latest M servo frames is acquired, the gain slice is recalculated, and the gain slice is re-set up for every M servo frames, so that the detection method of the HFW-related failure, which is less likely to be hardly affected by the variation between cylinders, is realized.

FIG. 8 schematically shows an example of averages (Gavg1, Gavg2, Gavg3, Gavg4) of the RRO gains for two servo frames of the track shown in FIG. 3, the sums (Gavg1+ΔG, Gavg2+ΔG, Gavg3+ΔG, Gavg4+ΔG) of the averages of the RRO gains and the offsets, and the gain slice. That is, FIG. 8 shows an example of the case where M in FIG. 7 is 2.

In the example shown in FIG. 8, the first to sixth servo frames are determined to have no occurrence of the HFW-related failure, whereas the seventh servo frame is determined to have the occurrence of the HFW-related failure.

It is noted that the functions for performing processes S11 to S17 described above are executed mainly by the controller 20 (especially, the CPU 23), which is not particularly limited as long as it is the element of the magnetic disk device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk comprising a plurality of tracks, the plurality of tracks each including a plurality of servo areas, the plurality of servo areas each including first servo data including data regarding eccentricity of the magnetic disk;
a head to write data to the magnetic disk and read data written to the magnetic disk; and
a controller to determine whether floating of the head from the magnetic disk is abnormal or not based on a signal corresponding to the first servo data read by the head while writing the data on the magnetic disk by the head.

2. The device according to claim 1, wherein the first servo data is written by the head after the magnetic disk is loaded in the disk device.

3. The device according to claim 1, wherein the plurality of servo areas each further comprises second servo data different from the first servo data.

4. The device according to claim 3, wherein the second servo data comprises a preamble section, a Gray code section and a burst section.

5. The device according to claim 1, further comprising a spindle motor to rotate the magnetic disk, wherein the data regarding the eccentricity comprises data for correcting the eccentricity of the magnetic disk rotated by the spindle motor.

6. The device according to claim 1, wherein the controller controls the head to draw a circular orbit on a basis of a rotation center of the magnetic disk.

7. The device according to claim 1, wherein the controller stops the writing of data to the magnetic disk by the head when the floating is determined to be abnormal.

8. The device according to claim 7, wherein the controller resumes the writing of the data to the magnetic disk by the head after the stopping the writing of the data.

9. The device according to claim 1, further comprising an amplifier to amplify the signal so as to have an amplitude at a constant level, wherein the controller determines whether the floating is abnormal or not based on gain of the amplifier to make the amplitude of the signal at the constant level.

10. The device according to claim 9, wherein the controller
counts number of times that a gain vale for each of the plurality of servo areas successively exceeds a particular value for each zone including the plurality of tracks, and
determines whether the number of counted times exceeds a particular number.

11. The device according to claim 10, wherein when the number of times exceeds the particular number, the controller determines that the floating is abnormal.

12. The device according to claim 9, wherein the controller
calculates a particular value based on an average of two or more gains corresponding to two or more servo areas of the plurality of servo areas for each of the plurality of tracks,
counts the number of times that the gains of servo areas following the two or more servo areas successively exceed the particular value, and
determines whether the number of times exceeds a particular number.

13. The device according to claim 12, wherein when the number of times exceeds the particular number, the controller determines that the floating is abnormal.

14. A method of determining floating of a head in a magnetic disk device,
the magnetic disk device comprising:
a magnetic disk comprising a track, the track including a plurality of servo areas, the plurality of servo areas each including first servo data including data regarding eccentricity of the magnetic disk; and
a head to write data to the magnetic disk and read data written to the magnetic disk,
the method comprising:
writing the data on the magnetic disk read by the head; and
determining whether floating of the head from the magnetic disk is abnormal or not based on a signal corresponding to the first servo data read by the head while writing the data.

15. The method according to claim 14, wherein the first servo data is written by the head after the magnetic disk is loaded in the disk device.

16. The method according to claim 14, wherein the plurality of servo areas each comprises second servo data different from the first servo data.

17. The method according to claim 14, wherein the data regarding the eccentricity comprises data for correcting the eccentricity of the magnetic disk rotated by a spindle motor to rotate the magnetic disk.

18. The method according to claim 14, further comprising stopping the writing of data to the magnetic disk by the head when the floating is determined to be abnormal.

19. The method according to claim 18, further comprising resuming the writing of the data to the magnetic disk by the head after the stopping the writing of the data to the magnetic disk by the head.

20. The method according to claim 14, the magnetic disk device further comprising an amplifier to amplify the signal so as to have an amplitude at a constant level, the method further comprising determining whether the floating is abnormal or not based on gain of the amplifier to make the amplitude of the signal at the constant level.
